(19) United States
(12) Patent Application Publication
(10) Pub. No.: US 2005/0284253 A1
(43) Pub. Date: Dec. 29, 2005

(54) Bicycle pedal

(76) Inventor: Dana P. Hervig, Inver Grove Heights, MN (US)

Correspondence Address: Dana P. Hervig, 1450 102nd St. E, Inver Grove Hts., MN, 55077, US

(21) Appl. No.: 10/876,064

(22) Filed: Jun. 24, 2004

(51) Int. Cl. G05G 1/14

(52) U.S. Cl. 74/594.6

(57) ABSTRACT

A pedal having a pedal shaft having first and second oppositely disposed ends, and an axis extending through the first end and the second end, the first end being connectable to a bicycle crank; a pedal housing mounted to rotate around said shaft about the axis of said shaft; a pedal frame pivotally mounted on two oppositely disposed housing hubs that extend along a longitudinal axis substantially perpendicular to the axis of said shaft; and housing projections that extend transversely from a side of the housing. The housing projections each have a projection surface that faces an underside of the pedal frame. Each projection surface is located below the top of the housing and is offset to a side of the housing to allow two pivot stops to interface between the projection surfaces and the pedal frame. The pivot stops can be adjusted, changed, or replaced to regulate the degrees of longitudinal pivoting of the pedal frame relative to the housing. A pedal as described can provide fixed or freely pivoting lateral adjustment on a heel to toe axis.

### BACKGROUND OF THE INVENTION

### TECHNICAL FIELD

This invention relates to a pedal for bicycles which pivots on a heel to toe axis that extends through longitudinal support hubs to provide lateral adjustability during pedaling. The most common bicycle pedals in the United States are not laterally adjustable; they have a pedal foot surface to pedal crank arm inside angle fixed at approximately 90 degrees. In U.S. Pat. Nos. 5,449,332, 5,628,710, and 6,241,639 Hervig shows pedals that provide lateral adjustability through a predetermined pivot range; These pedals pivot about a longitudinal axis with minimal bearing friction resistance and the selected addition of resistance provided from cushion pads of different densities. The original pedals shown by Hervig allowed pedal foot surface to pedal crank arm angle adjustments according to cyclist foot inputs in a range of approximately plus 6 degrees or minus 6 degrees from the standard 90 degree inside angle formed between the pedal foot surface and the pedal crank arm. The presently disclosed pedal functions as described in Hervig U.S. Pat. No. 6,241,639 with significant advantages relating to manufacturing, alternative methods of lateral pivot control and pedal profile relating to the use of hubs, clamps and the offset position of the housing projection surface. A housing projection extends transversely from the pedal shaft housing to provide a surface that can interface with a pivot stop which can contact the pedal frame to control the pedals canting which can be defined as the pedal's tilt on a heel to toe axis. The housing projection surface is offset from the main body of the shaft housing to allow an increased gap distance between the projection surface and the pedal frame. This allows more thread area in the frame, or alternatively, thread area in the housing projection to use a longer set screw. The increased gap will also allow use of larger types of pivot stops to further limit canting. As shown in the current invention, and in addition to the set screw type pivot stops as shown in Hervig U.S. Pat. No. 6,241,639, pivot stops made of various solid and cushioned materials may be attached to either the pedal frame or the offset housing projection surface to provide greater lateral adjustability without increasing the overall height of the pedal frame and shaft housing assembly. The lateral positioning range can be altered by using pivot stop blocks of different sizes or by an allen wrench adjustment of set screws from either the pedal frame surface or the underside of the extensions. By modifying a pedal according to the principles of Hervig's U.S. Pat. Nos. 5,449,332, 5,628,710, and 6,241,639 with the modifications shown in the present invention, it can be understood that the presently described pedal can, by adjustment of set screws or by insertion of a variety of pivot stop materials having different shapes and or densities, permit an infinite number of reduced ranges of lateral adjustability within the maximums of lateral adjustability. Also, by using the above described pivot stops and or set screws in combination, it is possible to set and hold the pedal to a specific lateral adjustment angle.

### SUMMARY OF THE INVENTION

A pedal includes a shaft housing having a coaxial rotatable shaft within that is connectable to a bicycle pedal crank. The shaft housing rotates about the pedal shaft on lubricated bearings. The housing has two oppositely disposed hubs that extend on a longitudinal axis that is approximately parallel with a cyclist's heel to toe axis. The pedal has a frame that is pivotally attached with clamps around replaceable lubricated bushings that cover the hubs. The pedal frame used can be of a conventional clipless type or platform type. The housing has two housing projections that are positioned to a side of the housing so that two pivot stops can interface between the projections and the frame without clearance interference from the pedal shaft. Pivot stops in the form of set screws can be threaded through the pedal frame or the projections to predetermine the pivot amount the pedal frame can pivot relative to the housing. Alternatively, pivot stops in the form of solid blocks or flexible blocks such as rubber blocks can be attached to either the projection surface or the frame to control pivot amount on the longitudinal axis. The offset position of the projections from the shaft portion of the housing can allow further extension of the pivot stops between the pedal frame and the housing to maximize pivoting versatility and to allow easier access to change with pivot stops having different sizes than pedals of prior art such as Hervig U.S. Pat. No. 6,241,639 which shows pivot stops placed between the pedal frame and the top of the housing. A pedal as described can provide fixed or freely pivoting lateral adjustment on a heel to toe axis.

### BRIEF DESCRIPTION OF THE DRAWINGS

The invention will be better understood, and objects other than those set forth above will become apparent when consideration is given to the following detailed description thereof. Such description makes reference to the drawings wherein:

FIG. 1 is an isometric view of a clipless bicycle pedal.

FIG. 2 is an exploded isometric view of a clipless bicycle pedal.

FIG. 3 is a rear isometric view of a pedal housing.

FIG. 4 is a front isometric view of a pedal housing.

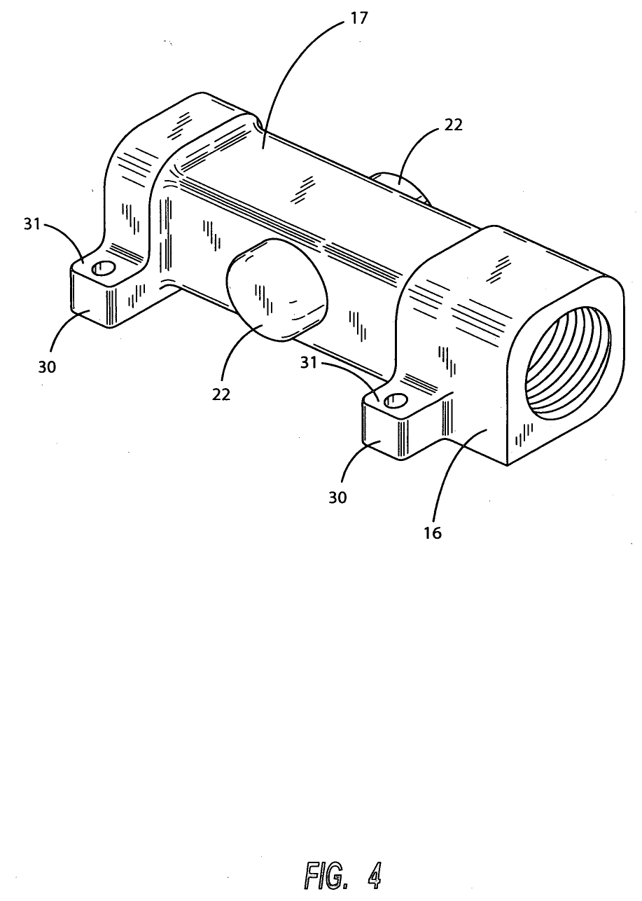

FIG. 5 is a bottom plan view of a clipless bicycle pedal frame with shaft housing, clamps and seals.

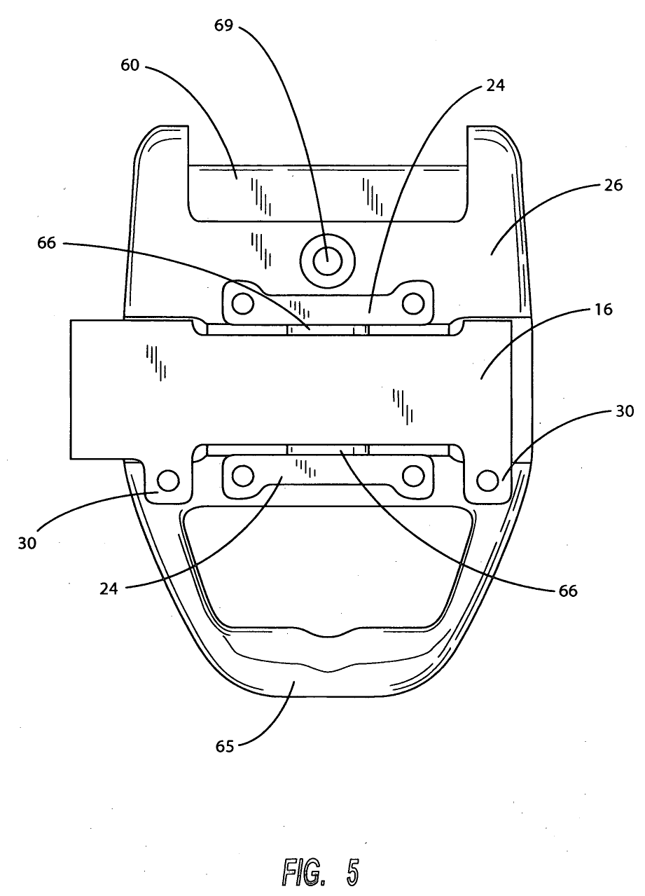

### DETAILED DESCRIPTION OF THE INVENTION

The preferred embodiment of the invention will be described in detail with reference to the drawings, wherein like reference numerals represent like parts and assemblies throughout the several views. Reference to the preferred embodiment does not limit the scope of the invention, which is limited only by the scope of the claims attached hereto.

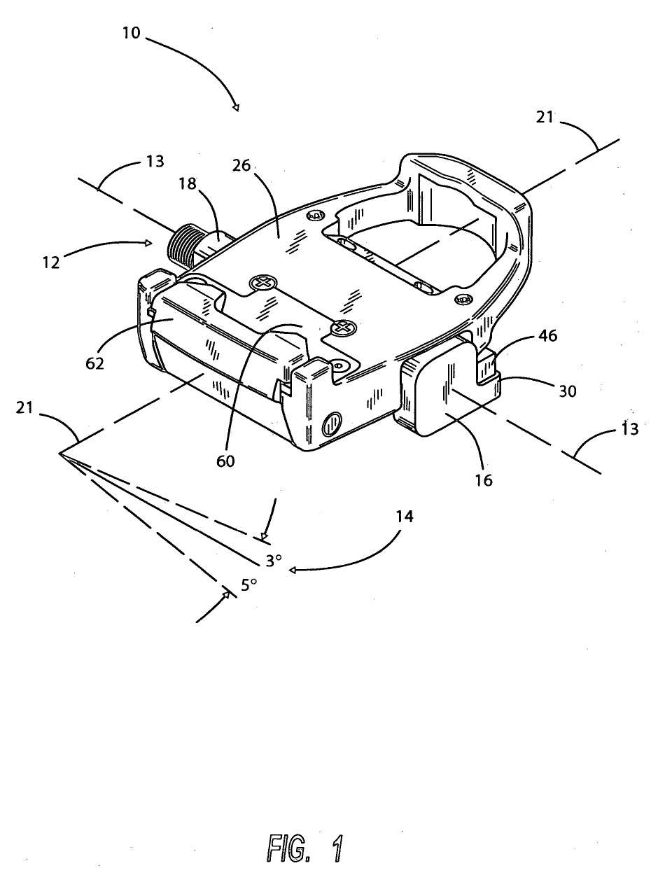

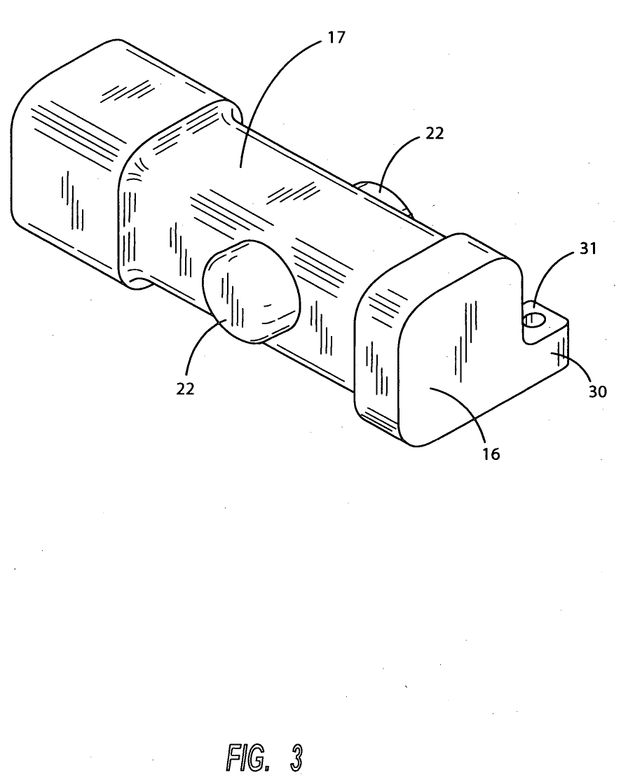

Referring now to FIGS. 1-3, the reference numeral 10, generally designates an embodiment of a bicycle pedal. The bicycle pedal 10 includes a pedal housing 16 having a rotational region 12 being provided for allowing the pedal 10 to freely rotate about the lateral rotational axis 13 and a longitudinal pivoting region 14 being provided for pivotal adjustment on longitudinal axis 21. Longitudinal axis 21 runs parallel to a cyclist's foot heel to toe axis. The rotational region 12 includes pedal housing 16 and a shaft 18. The shaft 18 is made of cro-moly steel, but can also be made of titanium or of another hardened material as currently used in the manufacture of bicycle pedals. Shaft 18 has a threaded end 20 which is connectable to a bicycle crank. Shaft 18 and pedal housing 16 rotate relative to each other on a sliding means such as precision bearings or ball bearings (not shown) or some similar rotation mechanism which is commonly known in the art and used in the manufacture of bicycle pedals.

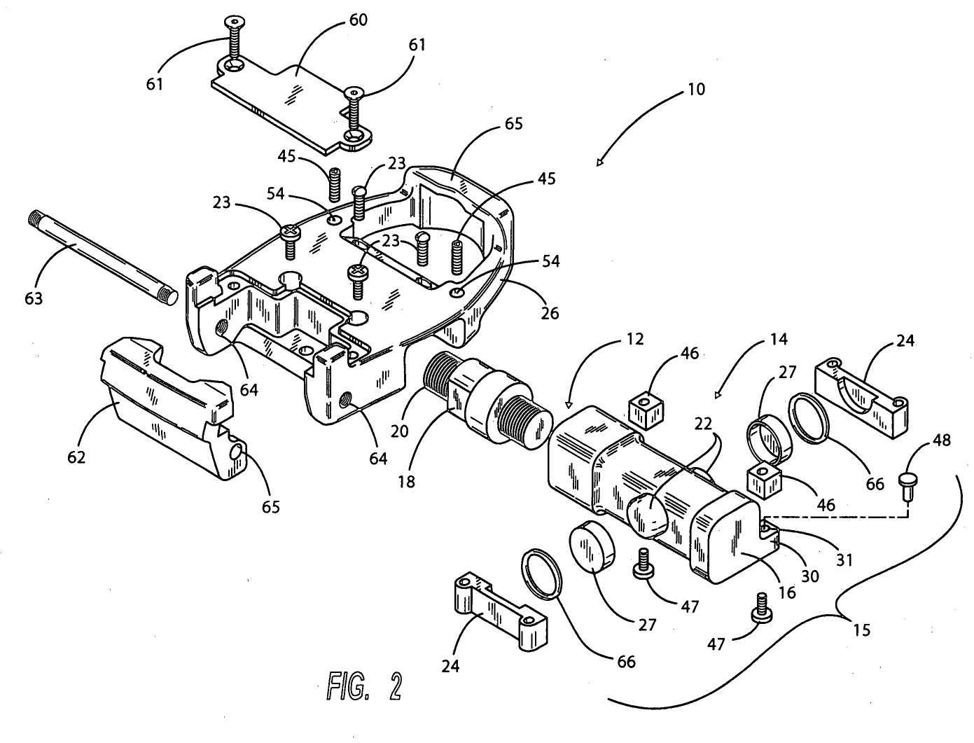

The pedal housing 16 is cast aluminum or resin or of a machined resin or aluminum that is hard anodized. Housing 16 includes two housing hubs 22 which extend perpendicularly from opposite sides of housing 16 to interface with pedal frame 26 and provide for longitudinal pivoting region 14. The assembly parts in group 15 of FIG. 2 comprise elements for pivoting region 14. Pedal frame 26 can be cast or machined aluminum or resin. Two clamp screws 23 are used to connect each of two resin or hard anodized aluminum clamps 24 to pedal frame 26. The connection of pedal frame 26 to housing hubs 22 allows clearance for the pivotal rotation of pedal frame 26 and clamps 24 about the support hubs 22. The pivotal contact points between pedal frame 26 and pedal housing 16 in FIG. 1 are support hubs 22. Between hubs 22, the inner portions of pedal frame 26, and the clamps 24 they contact is applied a lubricant i.e. grease to reduce friction and promote part longevity. Alternatively, oil impregnated brass bushings or plastic resin bushings 27 may be manufactured to cap the ends of hubs 22 and pivotally fit between clamp 24 and frame 26. In the event that housing 16 is made of an injected resin such as nylon, it would be desirable to have bushing 27 stamped and formed from stainless steel. Hubs 22 can be milled down or cast to receive bushings 27 which can be press fit on hubs 22 to allow a lubricated pivoting relationship with pedal frame 26 and clamps 24. Rubber seal rings 66 are placed over bushings 27 to keep dirt out of where bushings 27 pivot against pedal frame 26 and the clamps 24.

Pedal housing 16 has top and bottom oppositely disposed housing sides. In pedal 10, housing 16 has a top side 17 that is closest to pedal frame 26. Pedal housing 16 has a housing projection 30 that extends transversely from between the top and bottom sides of housing 16. Housing projection 30 has a housing projection surface 31 which is directed to face pedal frame 26. Pedal frame 26 has a pivot stop region that surrounds holes 54 and that is oppositely disposed to projection surface 31 to interface with the pivot stop. Housing projection surface 31 is shown to be below the top of housing 16 to extend the possible distance pivot stops 45 or 46 can extend between pedal frame 26 and pedal housing 16. Housing projection 30 supplies a sufficient amount of material beside housing 16 so a pivot stop, which can be a set screw 45, a block 46, or other commercially available material can extend between pedal frame 26 and projection surface 31 without positioning interference from pedal shaft 18. Housing projection 30 as shown has a tapped hole so that a set screw 45 can be threaded through it to interface with and limit the pivoting of pedal frame 26 on longitudinal axis 21. Alternatively, the tapped hole in housing projection 30 can receive screw 47 which can be inserted through projection 30 and threaded into block 46 to limit the gap between pedal frame 26 and projection surface 30. As another alternative, pedal frame 26 has a tapped hole 54 so that a set screw 45 can be threaded through it to contact the head of a steel rivot 48 which is is press fit into housing projection 30 through a hole in housing projection surface 31. The use of steel rivot 48 prevents set screw 45 from rapidly wearing out the aluminum or resin housing projection surface 31. Alternatively, block 46 can be held against pedal frame 26 by set screw 45. The block 45 used in the foregoing examples can be made of a variety of materials having different densities, flexibilities, and thicknesses to provide the desired amount and characteristics of pivoting of pedal frame 26 on longitudinal axis 21. Projection surface 31 is offset from the top and bottom sides of housing 16 to allow maximum extension of pivot stop 45 or 46 while retaining a close distance between pedal frame 26 and housing 16 to keep pedal 10 as compact as possible.

Pivot maximums on axis 21 are determined by either the amount of extension of the pivot stops 45 or 46 between the housing projection surface 31 and pedal frame 26 or by the clearance between the top of housing 16 and the underside portions of pedal frame 26 that housing 26 can pivot against when pivot stops 45 or 46 are not used. Without the use of pivot stops 45 or 46, pedal 10 will allow 5 degrees of inversion and 3 degrees of eversion. Pedal housing 16 is made with square sides as shown to maximize cushion pad adhesion and cushioning area when an optional adhesive backed cushion pad (not shown) is inserted between pedal frame 26 and pedal housing 16 to dampen longitudinal pivoting in conjunction with the use of set screws 45.

A clipless embodiment, pedal 10, is designed to retain the cleat of a cyclists shoe (not shown) between heel end retainer lever 62 and toe end retainer cup 65. As commonly used in the art of pedal manufacturing, heel retainer lever springs and spring tensioning hardware (not shown) are inserted with retainer lever shaft 63 to provide tension against lever 62 so that a cyclist's shoe cleat can be retained. Lever 62 permits free vertical axis pivoting or float for toe in and toe out foot positioning. A variety of clipless pedal hardware attachments are commonly available from pedal manufacturers such as from Shimano, Time, Wellgo, Look, Speedplay etc. Shaft 63 is inserted through shaft lever hole 65 and shaft frame holes 64 to allow the lever to pivot on pedal frame 26. Access plate 60 is attached to pedal frame 26 using two plate screws 61. Access plate 60 allows assembly of shaft 63 with the lever springs and spring tensioning hardware (not shown). Hole 69 is for a spring tensioning adjustment screw that can change the amount of spring tension applied to lever 62. As shown, the pedal in FIG. 1 permits foot adjustment on three axis—lateral, longitudinal and vertical.

While the invention has been described in conjunction with specific embodiments thereof, it is evident that different alternatives, modifications, variations, and uses will be apparent to those skilled in the art in view of the foregoing description. Accordingly, the invention is not limited to these embodiments or the use of elements having specific configurations and shapes as presented herein.

1. A pedal comprising;
(a) a pedal shaft having first and second oppositely disposed ends, and an axis extending through the first end and the second end, the first end being connectable to a bicycle crank;
(b) pedal housing mounted to rotate around said shaft about the axis of said shaft, said housing having top and bottom oppositely disposed sides;
(c) pedal frame pivotally mounted on the housing on a longitudinal axis substantially perpendicular to the axis of the shaft;
(d) housing projection extending transversely from between said top and bottom housing sides, said housing projection having a projection surface directed towards said pedal frame;
(e) pivot stop extending between the pedal frame and said projection surface, wherein the housing projection extends from between the top and bottom housing sides as a means to allow extension of said pivot stop to limit pivotal movement of the pedal frame relative to the pedal housing on said longitudinal axis.

2. The pedal according to claim 1, wherein said pedal frame provides freedom for toe in and toe out pivoting via an attachment means on the pedal frame for connection to a cyclist's shoe.

3. The pedal according to claim 1, wherein a cushioning/dampening means between the projection surface and the pedal frame provides cushioning when the pedal frame is pivoted relative to the projection surface.

4. The pedal according to claim 1, wherein the longitudinal axis pivoting movement is between about 1 and 24 degrees.

5. The pedal according to claim 1, wherein the pedal frame has a top contact surface with clamping means for connection to a cyclist's shoe.

6. The pedal according to claim 1, wherein the pivot stop is a set screw that threads into the pedal frame and extends from the pedal frame to the projection surface.

7. The pedal according to claim 1, wherein the pivot stop is a set screw that threads into said housing projection and extends from the projection surface to the pedal frame.

8. The pedal according to claim 1, wherein the pivot stop is a solid block fastened to the pedal frame to extend to the projection surface.

9. The pedal according to claim 1, wherein the pivot stop is a solid block fastened to the projection surface to extend towards the pedal frame.

10. The pedal according to claim 1, wherein the pedal housing has a hub that is pivotally mounted to the pedal frame with a clamp.

11. The pedal according to claim 10, wherein said hub is covered by a bushing.

12. The pedal according to claim 10, wherein a ring shaped seal is fit around said hub.

13. The pedal according to claim 1, wherein the pedal frame has a forward cleat retainer and a spring loaded rear cleat retainer to hold the cleat of a cyclist's shoe.

14. The pedal according to claim 1, wherein the pedal frame has a cleat retainer spring tension adjustment screw.

15. The pedal according to claim 1, wherein the projection surface has connection means to attach to the pivot stop.

16. The pedal according to claim 1, wherein the pedal frame has connection means to attach to the pivot stop.

17. The pedal according to claim 1, wherein the projection surface has a connection means to attach a steel rivot.

18. The pedal according to claim 1, wherein the pedal housing has approximately square top and bottom sides.

19. The pedal according to claim 1, wherein the pedal frame has a pivot stop region oppositely disposed to the projection surface to interface with the pivot stop.
